(19) United States
(12) Patent Application Publication
(10) Pub. No.: US 2008/0216456 A1
(43) Pub. Date: Sep. 11, 2008

(54) Filter apparatus and method

(76) Inventor: Kevin D. Williams, Rochester, NY (US)

Correspondence Address: JAMES RAY & ASSOCIATES, 2640 PITCAIRN ROAD, MONROEVILLE, PA, 15146, US

(21) Appl. No.: 12/072,257

(22) Filed: Feb. 25, 2008

Related U.S. Application Data
(60) Provisional application No. 60/892,928, filed on Mar. 5, 2007.

(51) Int. Cl. B01D 46/00

(52) U.S. Cl. 55/496

(57) ABSTRACT

A filter apparatus removably attachable to at least one of a door frame, a window frame, a screen, a wall, a door, and a window is provided. Such filter apparatus includes a filter member, manufactured from a first predetermined material and having a first predetermined size and a first predetermined shape, for filtering dust, debris, pollutants, insects, dirt, allergens, pollen, rain, and irritants. A frame member is manufactured from a second predetermined material and has a second predetermined size and a second predetermined shape. A mechanism is provided for operably connecting such filter member to such frame member. A fastening mechanism is provided for removably fastening such frame member to at least one of such door frame, such window frame, such screen, such wall, such door, and such window.

### CROSS REFERENCE TO RELATED APPLICATION

This patent application is related to and claims priority from U.S. Provisional Patent Application Ser. No. 60/892,928 filed Mar. 5, 2007.

### FIELD OF THE INVENTION

The present invention relates, in general, filters to and, more particularly, this invention relates to window and door filters to block dust, rain, pollutants, plant spores, pollen, insects and the like.

### BACKGROUND OF THE INVENTION

Prior to the conception and development of the present invention, filters, as are generally well known in the prior art, have been used in furnaces and air conditioning units, but have not been applied to windows and doors.

Specifically of interest to the present invention are the following: Weed, U.S. Pat. No. 3,675,402, discloses an adjustable filter assembly for doors and windows consisting of a screen and frame assembly.

Wolfe, U.S. Pat. No. 5,312,467 discloses a window air filtering assembly. The air filtering assembly includes a frame assembly and a filtering medium disposed in the frame assembly. The filtering medium is formed from woven, smooth-surfaced microfilament strands having at least 16% of its surface area open.

Spies, et al, U.S. Pat. No. 5,951,727 discloses an air-permeable filter material for use on doors, door frames, windows or window frames and a method of using the filter material to protect against the ingress of pollen and dirt particles in the environment. The filter material may be composed of fabric or film or a combination of film and fabric.

Yatsunori, et al, JP20040185088 20040623, discloses a pollen intrusion preventive net material for placement over the net part of a window screen body.

Pooth, DE4300422, discloses a protective filter arrangement fitted to closable and non-closable apertures in rooms, cars, tents, and boats, made from a material which deflects wind, water, dirt, pollen, dust, and insects.

### SUMMARY OF THE INVENTION

The present invention provides a filter apparatus removably attachable to at least one of a door frame, a window frame, a screen, a wall, a door, and a window. Such filter apparatus includes a filter member, manufactured from a first predetermined material and having a first predetermined size and a first predetermined shape, for filtering dust, debris, pollutants, insects, dirt, allergens, pollen, rain, plant spores, and irritants. A frame member is manufactured from a second predetermined material and has a second predetermined size and a second predetermined shape. A means is provided for operably connecting such filter member to such frame member. Such filter apparatus further includes a fastening means for removably fastening such frame member to at least one of such door frame, such window frame, such screen, such wall, such door, and such window.

A method of preventing dust, debris, pollutants, insects, dirt, allergens, pollen, rain, plant spores, and irritants from passing through an opening in at least one of a wall, a door, a window and a screen is provided. Such method includes providing a filter member manufactured from a first predetermined material and having a first predetermined size and a first predetermined shape. Providing a frame member manufactured from a second predetermined material and having a second predetermined size and a second predetermined shape. Operably connecting such frame member to such filter member at a predetermined location thereon. Providing a fastening means for removably fastening such frame member to at least one of such door frame, such window frame, such screen, such wall, such door, and such window. Removably fastening such frame member to at least one of such door frame, such window frame, such screen, such wall, such door, and such window.

### OBJECTS OF THE INVENTION

It is, therefore, one of the primary objects of the present invention to provide a filter apparatus that can be applied to an opening already having an existing screen in place.

Another object of the present invention is to provide a filter apparatus that will prevent dust, debris, pollutants, insects, dirt, allergens, pollen, rain, irritants and the like from entering a house or building and which will provide additional privacy for the occupants.

Still another object of the present invention is to provide a filter apparatus that will protect allergic and asthmatic users from irritants.

Yet another object of the present invention is to provide an easy to install filter apparatus for use on any size door, window, or other opening.

An additional object of the present invention is to provide a filter apparatus that can be cut to any dimensions and easily fastened to a window frame, door frame, window or door.

Still another object is to provide a method of filtering dust, debris, pollutants, insects, dirt, allergens, pollen, rain, irritants and the like from air passing through an opening in at least one of a wall, a door, a window and a screen.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention, according to one embodiment of the invention, as it is about to be placed over a screened window.

FIG. 2 is a partial perspective view of the invention according to one embodiment of the invention.

FIG. 3 is a partial perspective rear view of the invention according to one embodiment of the invention in which an adhesive means is attached to the frame member for removably attaching the frame member to at least one of a door frame, a window frame, a screen, a wall, a door, and a window.

FIG. 4 is a partial perspective view of the invention according to one embodiment of the invention.

FIG. 5 is a partial perspective rear view of the invention according to one embodiment of the invention in which a first portion of a hook and loop type fastening means is attached to the frame member of the filter apparatus and a second portion of such hook and loop type fastening means is attached to a window frame such that the invention may be fastened to such window frame.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

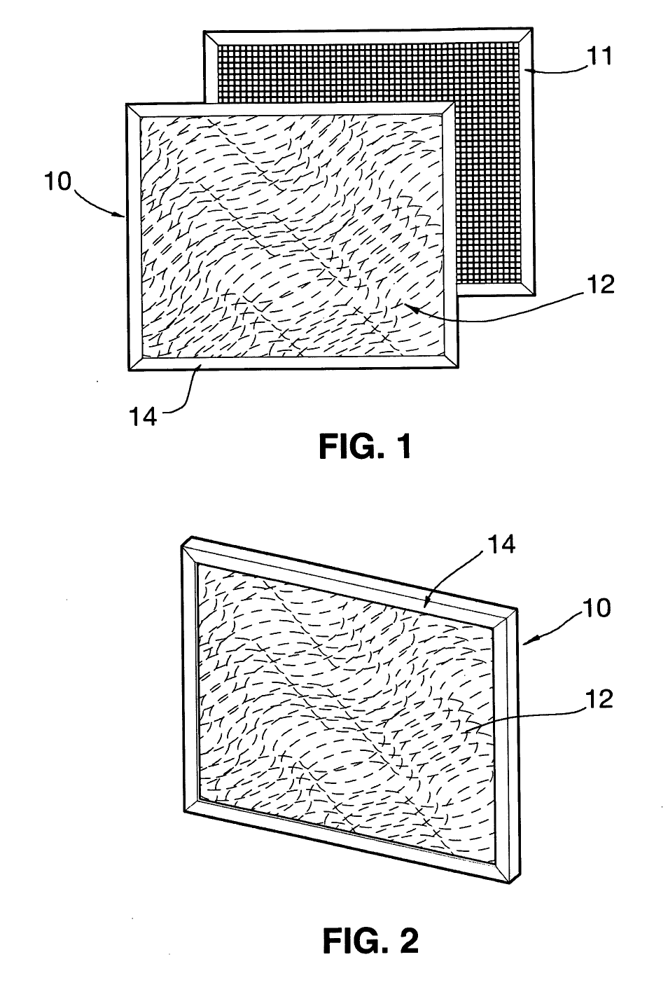

Reference is now made, more particularly, to FIGS. 1-5.

A filter apparatus, generally designated 10, is removably attachable to at least one of a door frame, a window frame 11, a screen, a wall, a door, and a window. Such filter apparatus 10 includes a filter member 12, manufactured from a first predetermined material and having a first predetermined size and a first predetermined shape, for filtering dust, debris, pollutants, insects, dirt, allergens, pollen, rain, plant spores and other irritants.

It is presently preferred that such first predetermined material is at least one of plastic, fabric, metal, fiberglass, synthetic fibers and a combination thereof. It is presently preferred that such fabric is at least one of cotton, netting and mesh. Such first predetermined material may also be at least one of a screen and a fiber mesh.

It is further presently preferred that such filter member 12 may be at least one of cut and trimmed to a predetermined size. It is presently preferred that such filter member 12 has a predetermined scent. It is presently preferred that such filter member 12 is washable. It is also presently preferred that such filter member 12 is at least partially transparent.

A frame member 14 is manufactured from a second predetermined material and having a second predetermined size and a second predetermined shape. It is presently preferred that such second predetermined material is at least one of wood, plastic, and metal. It is presently most preferred that such second predetermined material is plastic. It is further presently preferred that such frame member may be at least one of cut and trimmed to a predetermined size.

Such filter apparatus 10 includes a means 16 for operably connecting such filter member 12 to such frame member 14.

As illustrated in FIG. 4, it is presently preferred that such frame member 14 includes a generally U-shaped elongated cavity 18 and the means 16 for connecting such filter member 12 to such frame member 14 includes an at least partially rounded elongated member 20 operably connectable to such filter member 12 and disposable within such cavity 18 for holding such filter member 12 therein.

A fastening means 22 is also included for removably fastening such frame member 14 to at least one of such door frame, such window frame 11, such screen, such wall, such door, and such window.

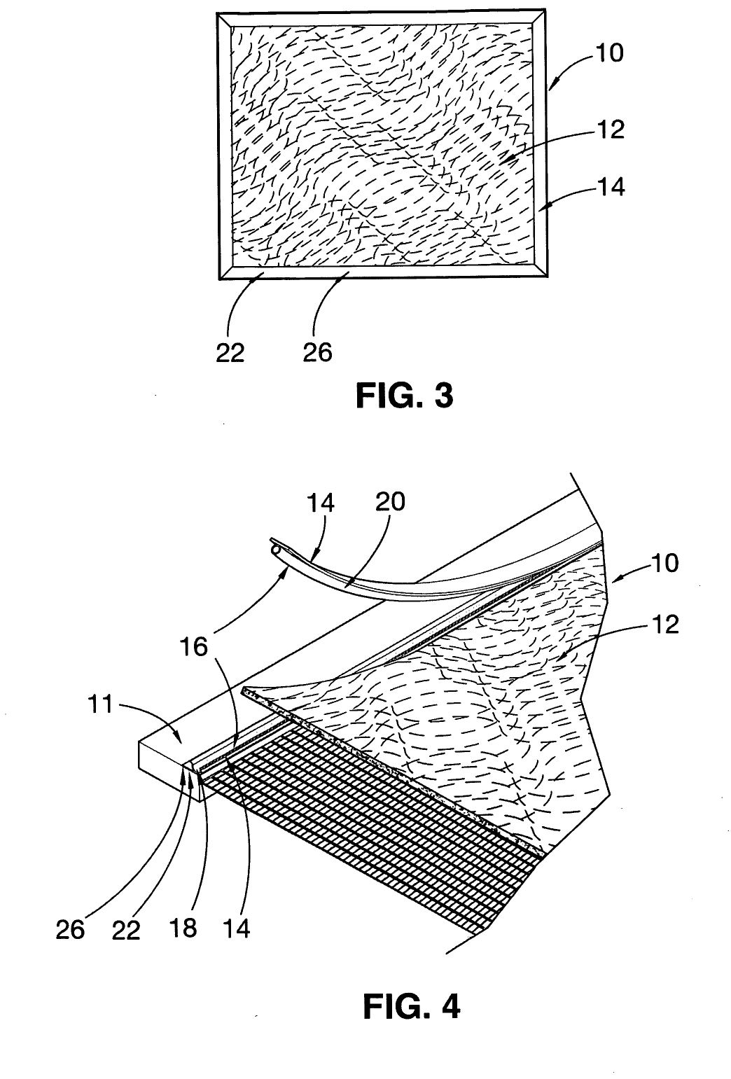

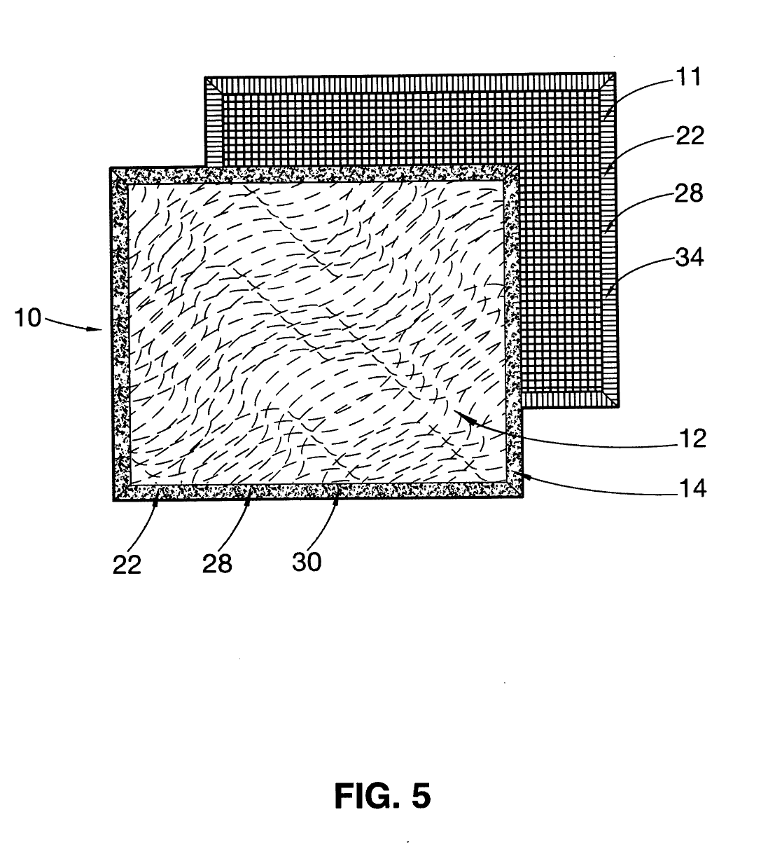

It is presently preferred that such fastening means 22 is an adhesive type fastening means 26 as illustrated in FIGS. 3-4. Such fastening means could also be a hook and loop type fastening means 28 as illustrated in FIG. 5.

Additionally, the filter member and frame member may be manufactured in a variety of colors. Furthermore, logos, such as sports and trade logos, as well as other indicia including but not limited to pictures, symbols, lettering, words, and the like may be included on such filter member and such frame member thereby appealing to a wide variety of consumers and adding aesthetically pleasing features to the invention.

According to another embodiment, a method of preventing dust, debris, pollutants, insects, dirt, allergens, pollen, rain, plant spores, irritants, and the like from passing through an opening in at least one of a wall, a door, a window and a screen is provided.

Such method includes providing a filter member 12 manufactured from a first predetermined material and having a first predetermined size and a first predetermined shape. Providing a frame member 14 manufactured from a second predetermined material and having a second predetermined size and a second predetermined shape. Operably connecting such frame member to such filter member 12 at a predetermined location thereon.

Providing a fastening means 22 operably connected to at least one of such frame member 14, such wall, such door, such window, such screen, a door frame, and a window frame 11 for removably fastening such frame member 14 to at least one of such wall, such door, such window, such screen, such door frame, and such window frame 11. Removably fastening such frame member 14 to at least one of such wall, such door, such window, such screen, such door frame, and such window frame 11.

It is presently preferred that removably fastening such frame member 14 to at least one of such wall, such door, such window, such screen, such door frame, and such window frame 11 includes fastening a first portion 30 of a hook and loop type fastening means 28 to a predetermined rear portion of such frame member 14 and fastening a second portion 34 of such hook and loop type fastening means 28 to a predetermined location on at least one of such wall, such door, such window, such screen, such door frame, and such window frame 24, and joining the first portion 30 with the second portion 34 such that such filter member 12 covers a predetermined portion of at least one of such wall, such door, such window, such screen, such door frame, and such window frame 11.

It is presently preferred that such method further includes providing a scenting means operably connected to such filter member 12 for providing a predetermined scent.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A filter apparatus removably attachable to at least one of a door frame, a window frame, a screen, a wall, a door, and a window, comprising:
a. a filter member, manufactured from a first predetermined material and having a first predetermined size and a first predetermined shape, for filtering dust, debris, pollutants, insects, dirt, allergens, pollen, rain, plant spores and irritants;
b. a frame member manufactured from a second predetermined material and having a second predetermined size and a second predetermined shape;
c. a means for operably connecting said filter member to said frame member; and
d. a fastening means for removably fastening said frame member to at least one of such door frame, such window frame, such screen, such wall, such door, and such window.

2. A filter apparatus according to claim 1 wherein said filter member has a predetermined scent.

3. A filter apparatus according to claim 1 wherein said fastening means is an adhesive type fastening means.

4. A filter apparatus according to claim 1 wherein said fastening means is a hook and loop type fastening means.

5. A filter apparatus according to claim 1 wherein said second predetermined material is at least one of wood, plastic, and metal.

6. A filter apparatus according to claim 4 wherein said second predetermined material is plastic.

7. A filter apparatus according to claim 1 wherein said first predetermined material is at least one of plastic, fabric, metal, fiberglass, synthetic fibers and a combination thereof.

8. A filter apparatus according to claim 7 wherein said fabric is at least one of cotton, netting and mesh.

9. A filter apparatus according to claim 1 wherein said first predetermined material is at least one of a screen and a fiber mesh.

10. A filter apparatus according to claim 1 wherein said filter member is washable.

11. A filter apparatus according to claim 1 wherein said filter member may be at least one of cut and trimmed to a predetermined size.

12. A filter apparatus according to claim 11 wherein said frame member may be at least one of cut and trimmed to a predetermined size.

13. A filter apparatus according to claim 1 wherein said filter member is at least partially transparent.

14. A filter apparatus according to claim 1 wherein said frame member includes a generally U-shaped elongated cavity and said means for connecting said filter member to said frame member includes an at least partially rounded elongated member operably connectable to said filter member and disposable within said cavity for holding said filter member therein.

15. A method of preventing dust, debris, pollutants, insects, dirt, allergens, pollen, rain, plant spores and irritants from passing through an opening in at least one of a wall, a door, a window and a screen, said method comprising the steps of;
a. providing a filter member manufactured from a first predetermined material and having a first predetermined size and a first predetermined shape;
b. providing a frame member manufactured from a second predetermined material and having a second predetermined size and a second predetermined shape;
c. operably connecting said frame member to said filter member at a predetermined location thereon;
d. providing a fastening means operably connected to at least one of said frame member, such wall, such door, such window, such screen, a door frame, and a window frame for removably fastening said frame member to at least one of such wall, such door, such window, such screen, such door frame, and such window frame; and
d. removably fastening said frame member to at least one of a such wall, such door, such window, such screen, such door frame, and such window frame.

16. The method, according to claim 15, wherein said method further includes providing a scenting means operably connected to said filter member for providing a predetermined scent.

17. The method, according to claim 15, wherein said removably fastening said frame member to at least one of a such wall, such door, such window, such screen, such door frame, and such window frame includes fastening a first portion of a hook and loop type fastening means to a predetermined rear portion of said frame member and fastening a second portion of said hook and loop type fastening means to a predetermined location on at least one of such wall, such door, such window, such screen, such door frame, and such window frame, and joining said first portion with said second portion such that said filter member covers a predetermined portion of at least one of such wall, such door, such window, such screen, such door frame, such window frame.
